(19) United States
(12) Patent Application Publication
(10) Pub. No.: US 2010/0108742 A1
(43) Pub. Date: May 6, 2010

(54) FRACTURE RESISTANT FRICTION STIR WELDING TOOLS

(76) Inventors: Israel Stol, Pittsburgh, PA (US); John W. Cobes, Lower Burrell, PA (US); Joseph M. Fridy, Pittsburgh, PA (US); Trent A. Chontas, Braddock Hills, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/632,219

(22) Filed: Dec. 7, 2009

Related U.S. Application Data
(62) Division of application No. 11/868,262, filed on Oct. 5, 2007.
(60) Provisional application No. 60/893,246, filed on Mar. 6, 2007.

(51) Int. Cl. B23K 20/12

(52) U.S. Cl. 228/2.1

(57) ABSTRACT

Friction stir welding tool to facilitate stress reduction within the tool that may include a body, a pin, a tension member, and an end assembly, the tension member and end assembly facilitating axial compression of the pin. The tension member may be decoupled from the pin and/or body of the tool via one or more decoupling members. The end assembly may comprise spring members to provide an axial force to the tension member. The pin may include various features to facilitate stress reduction proximal the pin.

### CROSS-REFERENCE TO RELATED APPLICATIONS

This application is a divisional application of U.S. Ser. No. 11/868,262 filed Oct. 5, 2007, which claims the benefit of U.S. provisional patent application No. 60/893,246 filed on Mar. 6, 2007, each of which is incorporated by reference herein in their entireties for all purposes.

### TECHNICAL FIELD

The present disclosure relates to friction stir welding tools and, more particularly, the present disclosure relates to friction stir welding tools having fracture resistant/stress reducing features.

### BACKGROUND

The friction stir welding (FSW) process is a solid-state based joining process, which makes it possible to weld a wide variety of materials (e.g., aluminum, copper, stainless steel) to themselves and to weld various combinations (e.g., aluminum alloys 6xxx/5xxx, 2xxx/7xxx) to each other. The process is based on plunging a rotating friction stir welding tool into the joining area. The rotating friction stir welding tool heats the workpiece(s) by friction, and thus the material becomes plasticized and flows around the axis of the tool due to shear caused by the rotating tool.

Conventional friction stir welding tools typically include a threaded pin, a shank and a shoulder having an engaging surface. The shank is for gripping in a chuck or collet of a friction stir welding machine so that tool can be rotated. While the tool is rotating, the pin is pressed and plunged into the joint area between the workpiece(s) which is/are to be welded. Friction between the workpiece(s) and pin causes the material of the workpiece(s) to become heated to its softening temperature and thus becomes plasticized. Pressure between the pin and the plasticized workpiece(s) causes the pin to be plunged into the workpiece(s). Friction between the pin and the workpiece(s) may cause plasticized workpiece material to flow about and around the axis of the pin allowing welding to occur without melting.

### SUMMARY

In view of the foregoing, a broad objective of the present disclosure is to produce improved friction stir welding tools. A related objective is to increase the fracture resistance of friction stir welding tools, such as when the tools are under cyclic fatigue loading during welding. A further related objective is to decrease the failure rate of friction stir welding tools that include an internal tension member. Another objective is to facilitate friction stir welding at higher operational speed and temperatures to facilitate welding of thick and/or strong and/or hard alloys and other materials.

In addressing one or more of the above objectives, a friction stir welding tool comprising a hollow body interconnected with, but decoupled from, an internal tension member may be used to eliminate or reduce the transfer of torsion forces from the pin to the tension member. In one embodiment, the tension member is decoupled from the body and/or pin of the friction stir welding tool via one or more decoupling members. The decoupling member may act as a swivel to restrict, and in some instances eliminate, the transfer of torsion forces from the body/pin of the friction stir welding tool. In one embodiment, the decoupling member comprises a thrust bearing (e.g., thrust ball-bearing; a high temperature thrust bearing material) located at or near a distal end of the tool body. Other decoupling members or materials may be used, such as various other bearing types (e.g., oil bearings, hydraulically driven bearings). Lubricants, such as dry lubricating powders (e.g., molybdenum-containing powders) may be applied between the tension member and the internal bore of the body/pin of the friction stir welding tool, thereby facilitating rotational and axial movement of the tension rod relative to the pin along a common axis.

In one embodiment, one or more spring members may be utilized to provide an axial force (e.g., a spring force) relative to the tension member, thereby axially tensioning the tension member and thus compressing the pin of the friction stir welding tool. In one embodiment, the spring members may also dampen tension variations experienced by the tension member due to interactions with the pin and/or due to temperature variations. The spring members may comprise one or more springs (e.g., disk springs) and may thus act as a bellows.

In some instances, hoop-type stresses induced in the pin by the shoulders of the internal tension member may be reduced by utilizing a non-linear interface/transition between the pin and the tension member shoulder. In one embodiment, the tension member shoulder includes at least one rounded portion for engagement with a corresponding rounded portion of the pin. In one embodiment, both the tension member shoulders and the corresponding internal pin shoulders include rounder portions with a gap therebetween. Thus, hoop-type stresses at the pin and tension member shoulder interfaces may be reduced.

In some instances, hoop stresses may be reduced by utilizing a pin having a larger diameter middle portion relative to the diameter of the base portion of the pin. In one embodiment, the pin diameter progressively decreases from the middle portion of the pin toward the base portion of the pin. Thus, the middle portion may be a bulging portion with increased surface area, thereby inducing a stress distribution in this region, which may reduce tension-type hoop stresses. This tapered diameter concept (e.g., larger middle diameter progressing to smaller base diameter) may also intensify the compression loading at the base of the pin, thereby reducing tensile stresses in this region. In other instances, a pin having a constant diameter from a middle portion to a base portion may be used (e.g., with high-strength tension members, described below).

In some instances, the tension member and the pin may comprise differing materials. In one approach, the tension member may employ metal alloys. The metal alloys may include fastener alloys and/or superalloys. In one embodiment, the metal alloy is a cobalt-based alloy. In another embodiment, the metal alloy is a steel-based alloy. In another approach, the tension member may comprise composite materials. In one embodiment, the composite materials include ceramics. The ceramics may include, for example, tungsten-based ceramics and materials including organic or carbon fibers. Since the tensile strengths of these materials may be significantly greater than the pin material (e.g., not less than about 500,000 ksi for a composite material compared to about 220 ksi for the pin material), the compression forces applied to the pin via the composite tension member may be significantly greater than the forces applied to the pin via the use of a tension member that is made of the same material as the pin. In turn, pin diameter may be decreased, and more durable pins may be produced. Smaller diameter pins may also afford higher welding speed of travel. Furthermore, the composite materials may have a higher temperature resistance, thus facilitating operation of the friction stir welding tool at higher temperatures.

The tension member may thus comprise bundles of composite type materials (e.g., a plurality of fibers), bars and/or rods and end-anchored cylinders that are produced (e.g., preformed, adhesively bonded, molded, cured, machined) with interconnection features that may be utilized to interconnect the tension member to the pin (e.g., via the rounded portions, described above) and/or the body of the friction stir welding tool. With respect to ceramic tension members, the ceramics may be anchored to the tool via any suitable anchor, such as complementary mechanical features (e.g., hooks/holes, dimples/recesses, tongue/groove) or via chemical bonding (e.g., superadhesives). In one embodiment, coolants may be provided to one or more of the tension member and/or pin during welding to assist in maintaining the integrity of those components.

In one embodiment, a composite tension member comprises a plurality of high-strength fibers (e.g., organic or carbon fibers) capable of twisting or rotational movement along a common axis within the bore of the body and/or pin of the friction stir welding tool as the tool operates. In this embodiment, the above-referenced decoupling member may not be needed as the plurality of fibers will eliminate or reduce the risk of breaking the torsion member due to transfer of torsion forces from the pin to the tension member.

In some instances, irrespective of the use of a monolithic pin (e.g., when utilizing a conventional friction stir welding tool) or a hollow pin (e.g., when utilizing a friction stir welding tool comprising a tension member), fracture resistance may be increased by utilizing a pin that includes at least one threadless band, which is located at the “base” of the pin next to the shoulder of the tool. The use of a threadless band may reduce stress-rising effects from the threads of the pin. This threadless band may be positioned about the pin at strategic locations to reduce pin failure at high fracture prone areas. In one embodiment, a threadless band is positioned proximal a shoulder portion of the tool, near the transition between the pin and the shoulder (e.g., at the base of the pin, next to the tool shoulder). In one embodiment, the threadless band has a width of at least about 2 mm. In one embodiment, the threadless band has a width of not greater than bout 8 mm.

In some instances, irrespective of the use of a monolithic pin (e.g., when utilizing a conventional friction stir welding tool) or a hollow pin (e.g., when utilizing a friction stir welding tool comprising a tension member), fracture resistance may be increased via threads that have a relatively high radius to depth ratio (r/d). The use of relatively high radius to depth ratios may reduce stress rising effects of the threads. In one embodiment, the radius to depth ratio is constant over the surface of the pin. In another embodiment, the radius to depth ratio progressively increases (e.g., linearly increases; exponentially increases) from a first portion of the pin toward a second portion of the pin. In one embodiment, the radius to depth ratio progressively increases from a middle portion of the pin toward a base portion of the pin.

In another approach, the pin may include threaded segments and bare portions. For example, the pin may include a plurality of segmented regions, some of which include threads and some of which do not include threads (e.g., bare portions or threadless band). The threaded segments may be spaced about the surface of the pin, with the bare portions separating the threaded segments from one another. In one embodiment, the pin includes three separate threaded segments spaced about the surface of the pin and separated by three bare portions. In one embodiment, the pin includes four separate threaded segments spaced about the surface of the pin and separated by four bare portions. In one embodiment, the threaded segments are spaced equidistance from one another, separated by bare portions. Each of the threaded segments may include the same thread pattern/orientation as the other threaded segments, or one or more of the threaded segments may include differing thread patterns. Hence, a first threaded segment may include a first thread pattern, and a second threaded segment may include a second thread pattern, the second thread pattern being different than the first thread pattern. In one embodiment, conventional uni-directional threads may be used for one or more of the threaded segments. In another embodiment, r-threads (e.g., left-hand, right-hand, horizontal) may be used for one or more of the threaded segments. One or more of the threaded segments may include one or more other surface features, such as dimples, intermittent grooves, or localized multi-faceted walls, to name a few. The bare portions are generally substantially bare of features (e.g., are substantially smooth) and can have a radius or round contour similar to the adjacent threaded sections or flat. The bare portions are approximately spaced every 90° to 120° apart. The use of threaded segments and bare portions may reduce the force(s) (e.g., Fz and Fx) and torque on the pin during welding, and may facilitate improved control over flow, fill-up and consolidation of the plasticized region about the pin. Extended pin lifetime may further be witnessed.

In one embodiment, the pin includes four threaded segments spaced equidistance from one another separated by bare portions. A first one and third one of these threaded segments may include a first threaded pattern (e.g., a right-hand pattern) and a second one and a fourth one of these threaded segments may include a second threaded pattern (e.g., a left-hand pattern). The first and third threaded segments may be on opposing sides of the pin and adjacent to bare portions. Likewise, the second and fourth threaded segments may be on the other opposing sides of the pin and adjacent bare portions.

In one embodiment, a friction stir welding tool generally includes a body, a pin, a tool shoulder, a tension member and, optionally, an end assembly. The body may define a cavity for receiving at least a portion of a tension member. The body may include a shank/grip for engagement with a chuck or collet of a friction stir welding machine. The end assembly comprises one or more of the above-described decoupling members and/or spring members. A distal end portion of the tension member may be interconnected with the end assembly (e.g. via a mechanical interface), which upon loading the tension member under tension may provide axial compressive force onto the tool's pin. A proximal end portion of the tension member may be interconnected with the pin (e.g., via transitions) and thus the pin may be axially compressed due to engagement of the tension member with the end assembly. Hence, cyclic tensile stresses due to bending moments on the pin as it rotates may be reduced. The tension member may comprise one or more of the above-described tension member related features (e.g., non-linear shoulder for interfacing with the pin). The pin may comprise one or more of the above-described pin-related features (e.g., linear tapered pin, bulging middle portion, segregated threaded portions, and non-linear internal transition for interfacing with the non-linear shoulder of a tension member). In one embodiment, a proximal end of the pin is contiguous with the working surface of the shoulder portion of the pin and shoulder. The tool shoulder portion may include a scrolled working surface for engaging at least one surface of the workpiece(s) to prevent plasticized material from flowing out of the plasticized region formed about and around the pin.

Various benefits may be evidenced via the inventive friction stir welding tools. For instance, the friction stir welding tools may be capable of welding materials that generally cannot be welded using conventional friction stir welding techniques. Materials requiring high weld temperatures and/or high toughness and/or high strengths may be welded using the improved friction stir welding tools. The friction stir welding tools may also facilitate welding of thicker sections of materials (e.g., a thickness of at least about 43 millimeters with a 7085 alloy). The friction stir welding tools may also facilitate faster welding speed, thereby increasing productivity and producing stronger welds due to the lowered heat inputs required per linear length. The friction stir welding tools may be utilized with numerous alloys and with numerous material thicknesses, thus reducing the number and types of apparatus required to complete welding operations. Tool life may be significantly extended, such as when welding tougher and stronger materials and/or thick sections of materials. Thus, the friction stir welding tools may be more cost effective.

As may be appreciated, various ones of the inventive features provided above may be combined in various manners to yield various friction stir welding tools. These inventive features may be utilized with conventional anvil-based tools, or with bobbin-type tools. Fixed and self-adjusting bobbin tools with multiple shoulders may be employed with any of the above-described features for simultaneously welding multiple parallel walls. Furthermore, the above inventive concepts do not generally require a redesign of the tool shoulder and/or compression sleeve. Hence, the tool shoulder may be any of a suitable configuration, such as a smooth configuration or a scrolled configuration with concentric rings or spiraled ridges, to name a few. These and other aspects, advantages, and novel features of the disclosure are set forth in part in the description that follows and will become apparent to those skilled in the art upon examination of the following description and figures, or may be learned by practicing the disclosure.

### BRIEF DESCRIPTION OF THE DRAWINGS

FIG. 1a is a perspective view illustrating one embodiment of a friction stir welding tool useful in accordance with the present disclosure;

FIG. 1b is a close-up, perspective view of the pin of the friction stir welding tool of FIG. 1a;

FIG. 1c is a cross-sectional side view of the friction stir welding tool of FIG. 1a;

FIG. 1d is a close-up, cross-sectional view of the interface between the tension member shoulder and the internal pin shoulder of FIG. 1c;

FIG. 1e is a perspective view of the tension member of FIGS. 1a-1d;

FIG. 1f is an exploded view of the end assembly of the friction stir welding tool of FIGS. 1a and 1c;

FIG. 1g is a side view of the friction stir welding tool of FIGS. 1a and 1c;

FIG. 1h is a side view of the pin of the friction stir welding tool of FIGS. 1a-1d and 1f-1g;

FIG. 1i is a close-up, cross-sectional view of the pin of the friction stir welding tool of FIGS. 1a-1d and 1f-1h;

FIG. 1j is an illustration of the threaded radius to depth dimensions;

FIG. 2a is a first side view of another embodiment of a pin useful with a friction stir welding tool;

FIG. 2b is a second side view of the pin of FIG. 2a;

FIG. 2c is a bottom view from the proximal end of the pin of FIGS. 2a-2b;

FIG. 3a is a side view of one embodiment of a friction stir welding tool having a transitioning shoulder assembly;

FIG. 3b is a cross-sectional, side view of the friction stir welding tool of FIG. 3a;

FIG. 4 is a cross-sectional side view of a bobbin-type friction stir welding tool;

FIG. 5 is a cross-sectional, side view of a case for transporting a friction stir welding tool;

FIG. 6 is a cross-sectional side view of one embodiment of a friction stir welding tool having a monolithic body;

FIG. 7 is a cross-sectional side view of one embodiment of a friction stir welding tool having a tapered tool shoulder;

FIG. 8 is a cross-sectional side view of one embodiment of a friction stir welding tool having a monolithic body and a tapered tool shoulder;

FIG. 9 is a side view of one embodiment of a friction stir welding tool having monolithic body with a straight tapered pin; and

FIG. 10 are side and cross-section views of another embodiment of the present disclosure.

### DETAILED DESCRIPTION

Reference will now be made in detail to the accompanying drawings, which at least assist in illustrating various pertinent embodiments of the present disclosure. For this application, monolithic is defined to describe a component that is made or formed into or from a single item and not from multiple parts; integral is defined as consisting or composed of parts that together constitute a component; follow is defined as having a cavity, gap, or space within, nest is defined as fitting snuggly together or within another or one another; and steady state condition is defined as thermal and mechanical stresses have stabilized and there are no significant variations of same over time.

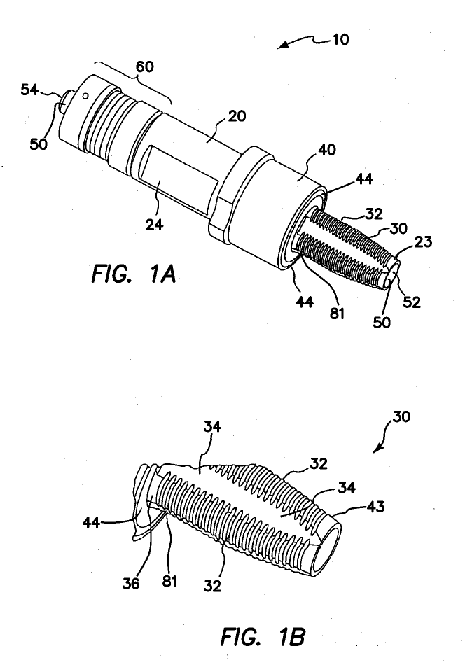

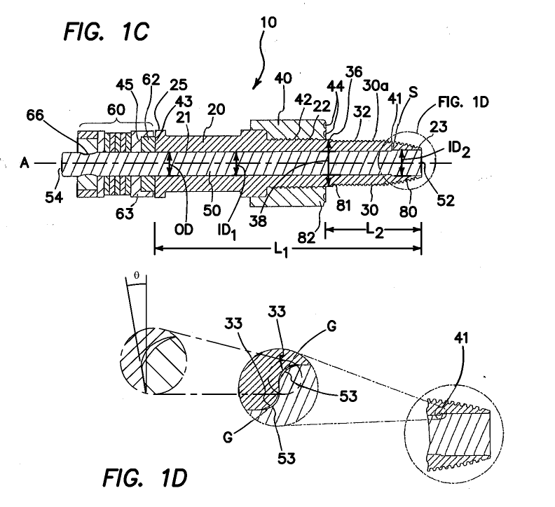

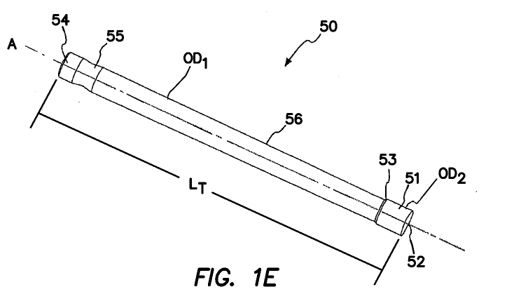

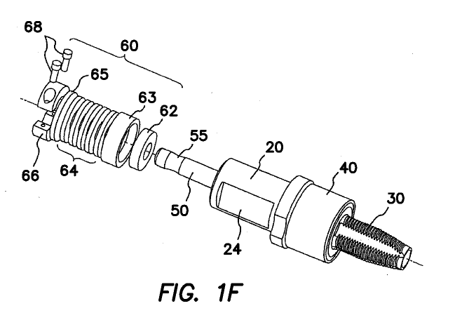

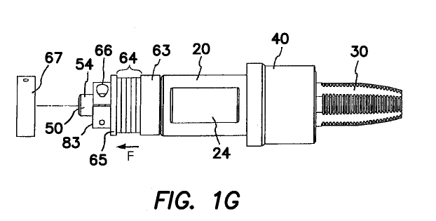

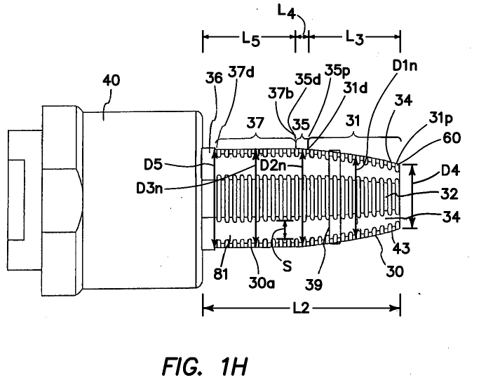

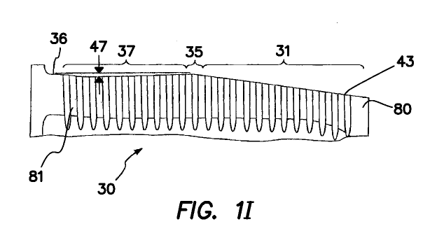

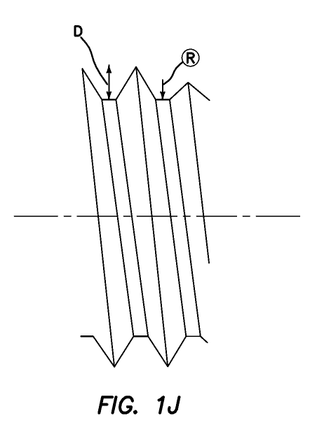

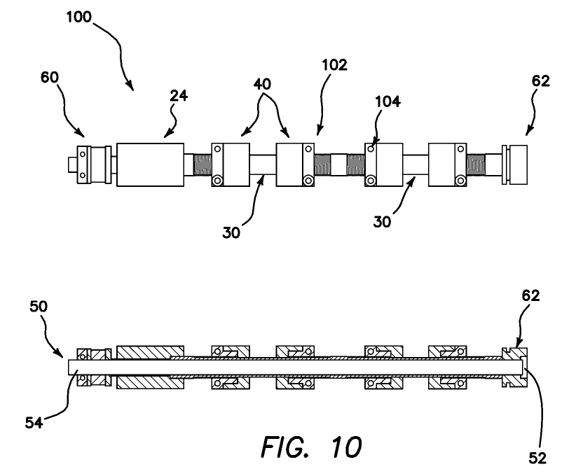

The present disclosure can be illustrated in many embodiments including those shown in FIGS. 1c and 10. For convenience, the detailed disclosure will profile the embodiment 10 illustrated in FIG. 1c. Common features between embodiment 10 and embodiment 100 shown in FIG. 10 are the same. It should be understood that the description (including torsional load path and stresses) that follows for embodiment 10 is also applicable to embodiment 100 and other embodiments contemplated but not shown herein.

Referring now to FIGS. 1a, 1c, and 1e, one embodiment of a friction stir welding tool 10 comprises a body 20 interconnected with a pin portion 30, a tool shoulder 40, a tension member 50, and an end assembly 60. The tension member 50 has a length L₁ and can be disposed within an internal bore 21 of the body 20 having length L₁ and extends therethrough. The tension member 50 is interconnected to the pin portion 30 via transitions 41 disposed near the proximal end 80 of the pin portion 30, as described in further detail below with respect to FIG. 1d. The end assembly 60 interconnects with and puts the tension member 50 in tension relative to body 20, as described in further detail below, thereby creating a closed-loop torsional load path or circuit. The end assembly 60 may include at least one decoupling member 62, described in further detail below, that facilitates decoupling of one end of the tension member 50 from the portion of the friction stir body 20 that directly cooperates with the drive system (not shown) of the friction stir welding machine (not shown) that induces the rotational speed (defined herein as input rotational speed and used synonymously with input torque) on to body 20 of the friction stir welding tool 10. The decoupling member 62 breaks or disengages the closed-loop circuit to relieve torsional load on the tension member 50.

One embodiment of a friction stir welding tool body 20 includes a friction stir welding machine drive system interface 24, such as grip portion as shown in FIG. 1a, capable of cooperation with a friction stir welding machine drive system (not shown) to apply an input rotational speed onto the friction stir welding tool body 20. The pin portion 30, which is adjacent and rigidly coupled to the friction stir welding machine drive system interface 24, will rotate at the same rotational speed or torque as the input rotational speed at steady state conditions prior to initiation of the friction stir welding operation. However, after pin portion 30 is plunged into a joint to be welded, there is torsional resistance on the pin, which is caused by the shear stresses between the plasticized material and the pin as a result the rotational speed (defined herein as output rotational speed and used synonymously with output torque) of the pin portion 30 can decrease as a result of resistance of the joint. Therefore, the output rotational speed can be less than the input rotational speed as the pin portion 30 plasticizes the material in the joint to be friction stir welded.

Now turning to FIG. 1e, one embodiment of the tension member 50 includes a proximal end portion 52 and a distal end 54. As disclosed above, proximal end 52 can be interconnected or fixedly coupled to the pin portion 30 to induce a compressive load thereon. The proximal end 52 rotates at substantially the same rotational speed as the pin portion 30 before, during, and after the friction stir welding operation. Distal end 54 can be operably connected to, via end assembly 60, with distal end 25 of body 20, which is located in close proximity to the friction stir welding machine drive system interface 24 (see FIG. 1c). Prior to disengagement distal end 54 has substantially the same rotational speed as the friction stir welding machine drive system interface 24. During the friction stir welding (FSW) operation when the output rotational speed is less than the input rotational speed, an angular displacement of the distal end 54 relative to the proximal end 24 may occur, which induces a torsional stress within tension member 50. This occurs because distal end 54 rotates at the input rotational speed and the proximal end 52 rotates at the output rotational speed, which may be different during FSW operation. A decoupling member 62 can be independently and operatively connected to the distal end 54 of the tension member 50 and the friction stir welding machine drive system interface 24 to decouple the distal end 54, for example, from body 20 in proximity to the source of input rotational speed. Other physical embodiments that result in decoupling the tension member 50 from the input source are contemplated herein. One such embodiment is decoupling member 62 capable of relative movement or slip to decouple the distal end 54 of the tension member 50 from body 20 in proximity to the friction stir welding machine drive system interface 24 when a predetermined torsional value or stress is exceeded, for example, at a decoupling member interface 43, 45 (FIG. 1c) with either the decoupling retainer 63 or distal end 25 of body 20, respectively. The predetermined torque value or stress can be determined by a normal force and a coefficient of friction at the decoupling member interface 43, 45. Thereby, the torsional stress within the tension member 50 caused by the angular displacement is reduced or eliminated when the decoupling member 62 effectively decouples or disengages the distal end 54 of the tension member 54 from the friction stir weld machine drive interface 24.

The physical interaction of the above components can be described in terms of torsional load path. As illustrated in FIGS. 1c and 1f, the above embodiment illustrates a torque release mechanism (decoupling member 62) that is not in the direct load path between the input drive source (friction stir welding machine drive system interface 24) and the output work tool (pin portion 30). This embodiment allows for flexibility in locating the torque release mechanism away from spatial constraints associated between the input drive source and the output work tool. For example, the torsional load path starts at the friction stir welding machine drive system interface 24 that is operably connected to the friction stir weld drive system (not shown) and rotates the entire tool 10 at a predetermined input rotational speed or torque when the tool 10 is not under load (no load mode). The three above named features rotate in unison until the pin portion 30 plunges into the joint to be welded and encounters resistance from the joint (load mode). Since the distal end 25 of body 20 is in close proximity to the friction stir welding machine drive system interface 24, distal end 25 of body 30 rotates at substantially the same rotational speed and load conditions as friction stir welding machine drive system interface 24. The torsional load realized by these features is negligible at steady state conditions prior to commencement of the friction stir welding operation (no load mode). When the pin portion 30 plunges into the joint, the rotational speed of the pin portion 30 decreases while the rotational speed of the other above named features stays substantially the same. This action creates a torsional load path that travels from the friction stir welding machine drive system interface 24 to the pin portion 30. (Note that the input drive source is between the torque release mechanism and the output work tool.) This results in an angular displacement between the proximate end 52 and distal end 54, which results in a torsional stress. The torsional load path travels from the pin portion 30 to the proximate end 52 of tension member 50 and continues to run the entire length of the tension member 50 to distal end 54, which is operably connected to the friction stir welding machine drive system interface 24 through the decoupling member 62, thereby completing the load path at the decoupling interfaces 43, 45. The intimate relationship of the components of the end assembly 60, discussed in detail below, results in no relative movement or slip therebetween while conditions are below the predetermined torque or stress value. Once the torque or stress value exceeds the predetermined value, the decoupling member 62 will slip or decouple at either decoupling interface 43 or 45 and interrupt or break the load path.

Now turning to FIGS. 1a and 1c, one embodiment of body 20 generally comprises a monolithic member having an axial bore 21 having inner diameters ID₁ and ID₂ extending through the longitudinal axis A for an entire length L₁ of the body 20 for receiving the tension member 50. Body 20 further includes proximal end 23 and distal end 25. The body 20 generally further includes friction stir welding machine drive system interface 24, such as a grip portion in the form of a cutout of the outer diameter, for facilitating grip of the friction stir welding tool 10 by a corresponding chuck or collet of a friction stir welding tool machine (not shown) having a drive system to induce the input rotational speed or torque. The body 20 may be made of any suitable material, such as, for example, cobalt or carbon-based steels. The body 20 further generally includes at least one set of complementary engaging features 22 (such as external threads) for receiving the complementary engaging features 42 (such as internal threads) of the tool shoulder 40 for facilitating interconnection of the tool shoulder 40 with the body 20. The pin portion 30 may be a portion of the monolithic body 20, as shown in FIG. 1c, at the proximal end 23 of body 20. In other embodiments, the pin may be a separate component that is interconnected to the body 20 via complementary engaging features to form an integral body/pin component. The dimensions of the body 20, pin portion 30, tool shoulder 40 and tension member 50 are generally application specific, and are dependent upon, for example, thickness, hardness and strength of the materials to be welded. The decoupling member 62 is disposed between the distal end 25 of the body 20 and the distal end 54 of the tension rod 50, wherein the decoupling member 62 inhibits or counters relative rotational or torsional movement along the common axis A of the tension member 50 with respect to the body 20 when an applied torque is below a predetermined torque value.

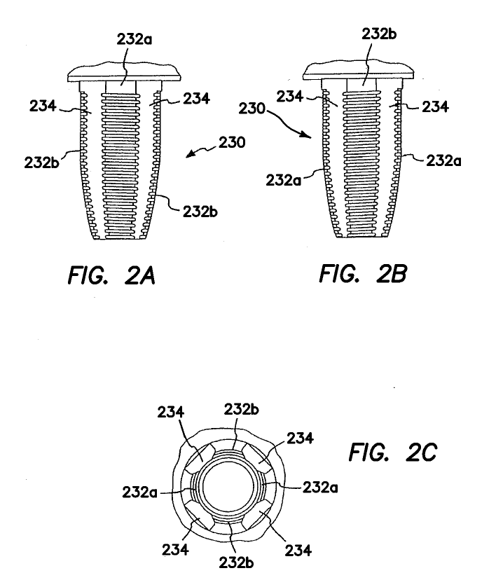

Referring now to FIGS. 1h and 1i, pin portion 30 generally comprises a plurality of external threaded segments or longitudinal portions 32 (hereinafter referred to as threaded sections 32) separated from one another by bare portions or threadless sections 34. The bare portions 34 are generally substantially bare of features (e.g., are substantially smooth) and can have a radius or round contour similar to the adjacent threaded sections or flat. The bare portions 34 are approximately space every 90° to 120° apart. The threaded segments 32 are located about the outer surface 43 of the pin portion 30. In the illustrated embodiment, the threaded segments 32 comprise right-hand threads. However, other threaded configurations may be utilized. For example, one or more of the threaded segments 32 may comprise a left-handed and/or a horizontal threaded portion, such as illustrated and described below with respect to FIGS. 2a-2c, or a combination thereof. The number, and size/dimensions of the threads and threaded segments 32 is generally application specific.

Now turning to FIG. 1j, the threads of the threaded portions 32 generally comprise a high radius (R) to depth (D) ratio. In one embodiment, the radius to depth ratio is constant throughout the threaded portions 32. In another embodiment, the radius to depth ratio is different for various threads of the threaded portions 32. In one embodiment, a first threaded portion comprises a first radius to depth ratio, and a second thread portion comprises a second radius to depth ratio, the second radius to depth ratio being different than the first radius to depth ratio. In one embodiment, the radius to depth ratio of at least some of the threads progressively increases as the threads proceed from a middle portion of the pin portion 30 towards the distal end 81 of the pin portion 30. In one embodiment, the radius to depth ratio linearly progressively decreases. In another embodiment, the radius to depth ratio non-linearly progressively decreases (e.g., exponentially progressively decreases). The use of relatively high radius to depth ratios and/or progressively changing radius to depth ratios may reduce stress rising effects of the thread on the pin portion 30, which may extend tool life. The radius to depth ratio is generally application specific.

Referring now to FIGS. 1c, 1d, and 1e as noted above, transitions 41 may be utilized to interconnect the tension member 50 to pin portion 30 of the body 20 of the friction stir welding tool 10. In one embodiment, and with reference to FIG. 1d, the transitions may comprise non-linear and complementary engaging surfaces of the pin portion 30 and the tension member 50. In the illustrated embodiment, the transitions comprise complementary engaging portions 33, 53. Thus, a smooth (e.g., non-abrupt) interface may be facilitated. One embodiment of the engaging portions 33, 53 are formed by difference diameters (ID₁, ID₂) of internal bore 21 and (OD₁, OD₂) of tension member 50, respectively. For example, ID₁ is smaller than adjacent ID₂, wherein engaging portion 33 is formed at the step or shoulder between the inner diameters (ID₁, ID₂), and OD₂ of proximal end 52 is larger than OD₁ of base portion 56, wherein engaging portion 53 is formed at step or shoulder 51. In a particular embodiment, the complementary engaging surfaces of at least one of the pin portion 30 and the tension member 50 comprise, for example rounded engaging surfaces 33, 53 that do not completely match, but leave one or more gaps G so as to decrease the likelihood that the tension member 50 will “nest” or seat within the pin portion 30. These gaps G may be provided by rounding the surface of the complementary rounded portions 33, 53 such that negative angles (A) are created, wherein at least a portion of the complementary engaging surfaces on the pin portion 30 and tension member 50 are slanted relative to the neutral axis of the pin portion 30. These non-linear complementary engaging surfaces may reduce hoop stresses in the pin portion 30 due to the compressive force.

Referring now to FIGS. 1a, 1b, 1c, and 1i the pin portion 30 may also include a threadless band 36 located near a distal end 81 of the pin portion 30. The threadless band 36 may extend about the entire perimeter of the pin portion 30 having a diameter 38 (FIG. 1c). The threadless band 36 comprises a width (w) that may vary or may be constant about the perimeter of the pin portion 30 (FIG. 1i). In one embodiment, the width (w) of the threadless band 36 is at least 2 mm. In a related embodiment, the width (w) of the threadless band 36 may be not greater than 8 mm. The threadless band 36 is generally located next to the proximal end 82 of the tool shoulder 40 so as to facilitate transitioning between the welding effects from the threaded segments 32 of the pin portion 30 and the welding effects from the working surface 44 of the tool shoulder 40. Thus, the threadless band 36 may facilitate reduction in stress-rising effects.

Referring now to FIGS. 1c, 1h, and 1i, the pin portion 30 may comprise varying diameters to facilitate stress reduction in the pin portion 30. In particular, and with reference to FIGS. 1h and 1i, the pin portion 30 may include a tip portion 31 with outer thread diameter D1 or plurality of outer threaded diameters D1ₙ, a middle portion 35 with outer thread diameter D2 or plurality of outer threaded diameters D2ₙ, and a base portion 37 with outer thread diameter D3 or plurality of outer threaded diameters D3. The outer diameter of the threads may progressively decrease as the outer threads; for example, proceed from the middle portion 35 towards the proximal end 80 of the pin portion 30 with outer diameter D4, wherein D2 is greater than D4. In a related embodiment, the outer diameter of the threads may progressively decrease as the outer threads proceed from the middle portion 35 towards the distal end 81 of the pin (i.e., toward threadless band 36) with outer diameter D5, wherein D2 is greater than D5. Thus, the pin portion 30 may comprise a bulged profile with a depression 47 near threadless band 36 as a result of the diametrical differences. This bulged profile may facilitate reduction in hoop stresses in the pin portion 30 by increasing the cross-sectional area in the middle portion 35 of the pin portion 30. In particular, the bulge portion may reduce hoop stress and yield through plastic deformation in region 39 (FIG. 1h) of pin portion 30.

In yet another embodiment, one or more other surface features, such as dimples, intermittent grooves, or localized multi-faceted walls, to name a few, instead of the threaded segments.

Referring now to FIGS. 1a and 1c, the tool shoulder 40 generally is interconnected with the body 20 of the tool 10 via complementary engaging features 22, 42. Such features may include, for example, male (external)/female (internal) threads. The tool shoulder 40 may be any suitable shoulder useful in a friction stir welding tool setting. For example, the tool shoulder 40 may be of a smooth configuration or of a scroll configuration with concentric rings and/or spiraled ridges, to name a few. A bottom portion of the tool shoulder 40 generally comprises a working surface 44, which acts to engage work pieces at the start of welding and during welding contain the plasticized material formed about and around the pin, directly underneath the working surface 44. Various working surfaces 44 are known in the art and any of such surfaces may be employed with the tool shoulder 40 of the friction stir welding tool 10.

Referring now to FIGS. 1a, 1c, 1d and 1e, the tension member 50 is generally designed to snugly fit within the chamber of the body 20 of the friction stir welding tool 10 such that tension member 50 and body 20 share a common longitudinal axis A. A snuggly fit is defined herein as the outer diameter(s) OD of tension member 50 is slightly smaller than inner diameter(s) ID of internal bore 21 of body 20. As discussed above, the tension member 50 is also generally designed to apply compression (e.g., axially compressive forces) to the pin portion 30. In the illustrated embodiment, the tension member 50 comprises a rod configuration, the rod having a base portion 56, a proximal end portion 52 and a distal end portion 54. The proximal end portion 52 comprises a tension member shoulder 51 and/or a corresponding complementary engaging surface 53 for engaging with a complementary engaging surface 33 of the pin portion 30, as described above. The distal end portion 54 generally comprises an engagement portion 55 for engaging with at least one member of the end assembly 60. In the illustrated embodiment, the engagement portion 55 comprises a recess for engagement with a split collar 66 of the end assembly 60 (discussed in further detail below). One embodiment of recess can be a convex shape, however any shape is acceptable. Another embodiment of the engagement portion 55 can include projections (not shown) that are received into openings (not shown) in split collar 66. Any complimentary features of the split collar 66 and engagement portion 55 that retains the split collar 66 to the tension member 50 and that does not interfere with the insertion and sliding of the tension member 50 into and through internal bore 21 is acceptable. For example, engagement portion 55 can include a spring loaded protrusion (such a ball) that can be depressed into the tension member 50 to allow it to enter and move freely through the internal bore 21 of body 20 and then extend sufficiently outward in a radial direction as it emerges or exits the internal bore 21 to engage a receiving member or opening of split collar 66. Thus, when the tension member 50 is interconnected with the other portions of the tool 10, as discussed in further detail below, at least one member of the end assembly 60 engages the engagement portion 55 of the tension member 50 and, in conjunction with other members of the end assembly 60, applies an axial tensile load on the tension member 50, the axial tensile force generally comprising a force vector oriented towards the distal end portion 54 of the tension member 50. As an axial tensile load is applied to the distal end 54 of the tension member 50, engaging features 53 of tension member shoulder 51 induce a force on the surface of the internal bore 21 in proximity of engaging feature 33. Thus, compression forces are realized at the pin portion 30 of the tool 10 via engagement of the tension member shoulder 51 with internal portions of the pin portion 30, which will reduce the mechanical assembly stress component and thereby, reduce the alternating tensile stress range during operation by starting with a lower minimum stress than would have been present without the induction of the compressive forces or loads. In turn, the pin portion 30 may be axially compressed during operation of the friction stir welding tool 10, which may reduce tensile stresses incurred by the pin portion 30 during operation of the friction stir welding tool 10.

The tension member 50 may comprise materials similar to those utilized for the body 20, the pin portion 30 and/or the tool shoulder 40, or materials differing from those components. In one embodiment, the tension member 50 comprises a high tensile strength material. In one embodiment, the tension member 50 comprises a metal alloy such as a fastener alloy and/or a superalloy. In a particular embodiment, the metal alloy may be a cobalt-based alloy. In another embodiment, the metal alloy may be a steel-based alloy. In another embodiment, the tension member 50 may comprise a composite material, such as a ceramic. The ceramic material may be, for example, a tungsten-based ceramic material. In another embodiment, the composite may comprise one or more bundles of ceramic organic or carbon fibers. With respect to ceramic materials, it may be appreciated that a recessed engagement surface, such as engagement portion 55, may not be readily attained due to difficulties arising in machining ceramic parts. Thus, in one embodiment of a tension member 50 comprising a ceramic material, the tension member 50 includes an anchor for anchoring the tension member 50 to at least one other portion of the tool 10, such as a body portion 20 or a pin portion 30. The anchor may be a mechanical fastener or a chemical fastener. In one embodiment, the anchor comprises complementary fastening features, such as hooks/holes, dimples/recesses and/or a tongue-groove arrangement, to name a few, a first one of which is utilized on the tension member 50, and a second one of which is utilized on at least one of the body 20, pin portion 30, and end assembly 60. In one embodiment, a chemical fastener is used, such as a high bond strength adhesive (e.g., a high temperature, super adhesive). In some instances, the tension member 50 generally comprises a monolithic body. However, in other instances, the tension member 50 may comprise separate components. For example, the tension member 50 may comprise a separate distal end portion and/or a separate proximal end portion for interconnection with the base portion of the tension member 50.

Referring now to FIGS. 1f and 1g, the end assembly 60 is generally utilized to achieve at least one of, and sometimes both of, the following: (i) axially tension the tension member 50 and (ii) decouple the tension member 50 from the body 20 and/or pin portion 30 of the friction stir welding tool 10. In the illustrated embodiment, the end assembly 60 comprises a decoupling member 62 and a decoupling retainer 63 for retaining the decoupling member 62. As discussed above, the decoupling member 62 facilitates decoupling of the tension member 50 from the body 20 of the friction stir welding tool 10. Thus, transfer of torque and/or other undesired forces from the base 20 and/or pin portion 30 to the tension member 50 may be restricted and/or eliminated. The decoupling member 62 may be, for example, a thrust bearing, such as a thrust ball-bearing and/or high temperature thrust bearing. In another embodiment, the decoupling member 62 may comprise different types of bearings, such as oil bearings and hydraulically-driven bearings. In one embodiment the rotational or torsional displacement of the distal end 54 relative to the proximal end 52 may be up to 15° prior to decoupling at a predetermined torque value. In another approach, the decoupling member 62 and its retainer may be absent from the end assembly 60, such as when the tension member 50 comprises one or more bundles of fibers that are capable of twisting during operation of the tool, hence reducing stress effects from the pin portion 30 and/or body 20 in the tension member 50.

Also, lubricants (such as a dry lubricating powder) may be applied between the tension member 50 and the internal bore of the body 20 and/or pin portion 30 of the tool 10, thereby facilitating movement (e.g., radial movement) of the tension member 50 relative to the body 20 and/or pin portion 30 of the tool 10. In one embodiment, the dry lubricating powder is a molybdenum-containing powder.

The end assembly 60 may also and/or alternatively include one or more spring members 64. Spring members 64 can be selected based on a spring constant (k) that yields the desired spring force to apply a tensile load on the tension member 50. In one embodiment, the spring members 64 include one or more springs, such as Belleville disk springs, that preload the tension member 50 with a designed tensile load when the end assembly 60 is engaged with the tension member 50. The spring members 64 may thus act to preload the tension member 50 with a desired force F in an axial direction relative to the pin portion 30. Also, a pneumatic drive system (not shown) can be adapted to the tool 10 to work in combination with or in place of the spring members 64. Thus, the pin portion 30 may be compressed, and reduced mechanical tensile stresses may be realized, as described above, which reduces the alternating stress range.

The spring members 64 may be utilized to dampen tension variations experienced by the tension member 50 due to interactions with the pin portion 30 and/or body 20 of the tool 10. The spring members 64 may further be utilized to dampen tension variations experienced by the tension member 50 due to temperature fluctuations during operation of the friction stir welding tool 10. Thus, the spring members 64 may act not only to provide the desired axial compression of the pin portion 30, but also to dampen tension variations experienced by the tension member 50. In the illustrated embodiment, the spring members 64 comprise disk springs that provide both dampening and compressing actions relative to tension member 50. It will be appreciated that, in other embodiments, separate components may be utilized to provide tensile loading to the tension member 50 and dampen tensile stress variations experienced by the tension member 50.

The end assembly 60 may include a collar 66 for engaging an engagement portion 55 of the tension member 50. The collar 66 may be, for example, a split collar having set screws 68 to facilitate engagement of the collar 66 with the engagement portion 55 of the tension member 50. A washer 65 may be utilized between the spring members 64 and the collar 66 so as to facilitate assembly of the end assembly 60. Once the decoupling member 62, spring members 64 and/or collar 66 are assembled and mounted to the tension member 50, a spring force F may be affected in the axial direction, as illustrated in FIG. 1g. To protect the distal end portion 83 of the end assembly 60, a retainer 67 may be interconnected with the collar 66.

The end assembly 60 may facilitate one or more functions with respect to the tension member 50. By way of primary example, the end assembly 60 may act to decouple the tension member 50 from the body 20 of the tool 10. By way of secondary example, the end assembly 60 may act to provide a tensile force with respect to the tension member 50, thereby compressing at least a portion of the pin portion 30 of the tool 10. By way of tertiary example, the end assembly 60 may facilitate dampening of the tension member 50 due to variations experienced by the tension member 50 from interactions with the pin portion 30 and/or body 20 of the tool 10, or due to temperature variations experienced by the tension member 50 during operation of the friction stir welding tool 10.

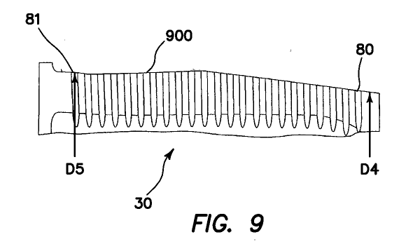

Another embodiment of pin portion 30 is shown in FIG. 9 to include a taper 900 as a result of the other diameters (D1ₙ, D2ₙ, D3ₙ, and D5ₙ, all shown in FIG. 1h) reducing linearly from D5 (or proximal end 81) to D4 (distal end 80). The linear reduction can be constant (straight taper as shown in FIG. 9) or vary (not shown).

As noted above, the pin portion 30 may include one or more threaded segments 32 for facilitating operation of friction stir welding tool 10. Each segment includes a predetermined length with a distal end and a proximal end that are directly adjacent to the respective a proximal end and a distal end of an adjacent segments or end of threadless band 36. For example, the end of threadless band 36 is directly adjacent to the distal end 37d of the threaded segment 37, the proximal end 37p of threaded segment 37 is directly adjacent to the distal end 35d of the threaded segment 35, and the proximal end 35p of threaded segment 35 is directly adjacent to the distal end 31d of the threaded segment 31. In another approach, one or more of the threaded segments 32 may comprise differing thread orientations relative to other threaded segments 32. In a particular embodiment, and with reference to FIGS. 2a-2c, a pin 230 may comprise a plurality of alternating threaded segments 232a, 232b. In the illustrated embodiment, the pin 230 comprises a first set of threaded segments 232a and a second set of threaded segments 232b. In the illustrated embodiment, the first set of threaded segments 232a comprises right-handed threads. The second set of threaded segments 232b comprises left-handed threads. Thus, the pin 230 comprises a first set of threaded portions comprising a first thread orientation, and a second set of thread segments, comprising a second thread orientation. Bare portions 234 are included between the threaded segments 232a, 232b. In the illustrated embodiment, the threaded portions 232a, 232b are spaced equidistance from one another, and the bare portions 234 are also thus spaced equidistant from one another, approximately 90° on center as shown in FIG. 2c. In the illustrated embodiment, the first thread segments 232a are separated from each other by bare portion 234 and adjacent second threaded segments 232b on either side of the first threaded segments 232a. Likewise, the second threaded segments 232b are separated from the first threaded segments 232a via adjacent bare portions and first threaded segments 232a on either side of the second threaded segments 232b. While left-handed/right-handed threaded orientations are illustrated, other thread orientations may be utilized, such as horizontal thread orientations. Further, the threads may include various other surface features, such as dimples, intermittent grooves, and localized multi-faceted flaps, to name a few. The use of varying thread orientations may facilitate more efficient mixing of plasticized regions about the pin 20/230 during operation of the friction stir welding tool 10. In turn, the forces and torque witnessed by the pin 20/230 during welding operations may be reduced. Improved control over flow, fill-up and consolidation of the plasticized regions about the pin 20/230 may also be witnessed, as well as improved pin life.

In one embodiment of pin portion 30, the outer diameters of the threaded segments are substantial constant along their respective lengths.

In another embodiment of pin portion 30, the outer diameters of the threaded segments are not substantial constant along their respective lengths.

In another embodiment of pin portion 30 (shown in FIG. 1h), the outer diameters D1ₙ of the threaded segment 31 increases from it proximal end 31p to the distal end 31d; the outer diameters D2ₙ of the threaded segment 35 increases from its proximal end 35p to a predetermined point P1 along a predetermined length along its length L4 and then decreases from the predetermined point P1 to its distal end 35d; and the outer diameters D2ₙ of the threaded segment 35 decreases from its proximal end 37p to its distal end 37d, whereby at the point where the ends of the adjacent threaded segments intersect, the outer diameters of the threaded sections are substantially the same. In other words, the outer diameter D1 of the distal end 37d of the threaded portion 31 is substantially equal to the outer diameter D2 of the proximal end 35p of the threaded end 35, and the outer diameter D1 of the distal end 35d of the threaded end 35 is substantially equal to the outer diameter D3 of the proximal end 3′7p of the threaded end 37.

In another embodiment of pin portion 30 (FIG. 1h), the plurality of threaded segments 32 circumscribe the outer surface 34 of the pin portion 30 for a portion of the length L2 of the pin portion 30 and at least two thread-less longitudinal sections 34 span the entire length L2 of the pin portion 30 that form equidistance spaces S between the plurality of threaded segments 32.

In another embodiment of pin portion 30, at least one threaded segment 32 is left-handed threads and another threaded segment 32 is right-handed threads (FIGS. 2a-2c).

In another embodiment of pin portion 30, all the threaded segments 32 are all either left-handed threads or all right-handed.

In another embodiment of pin portion 30, at least one segment (31, 35, or 37) comprises at least one outer diameter therein (D1ₙ, D2ₙ, or D3ₙ) that increases at a linear rate from proximal to distal ends, which is defined as the segment diameters along the segment length (L3, L4, or L5) increases or decrease at a constant or linear rate (positive or negative), for example 1 mm diameter increase for every 1 mm length of segment.

In another embodiment of pin portion 30, at least one segment (31, 35, or 37) comprises at least one outer diameter therein (D1ₙ, D2ₙ, or D3ₙ) that increases at a linear rate from proximal to distal ends, which is defined as the segment diameters along the segment length (L3, L4, or L5) increases or decrease at a non-constant or nonlinear or exponential rate, for example 1 mm diameter increase for the first 1 mm length of segment and when an increase or decrease in diameter that is not a 1 mm diameter increase for the subsequent 1 mm length of segment.

In another embodiment of pin portion 30, at least one segment (31, 35, or 37) comprises outer diameters (D1ₙ, D2ₙ, or D3ₙ) that increase at a linear rate (FIG. 9) and at least one outer diameter of the outer diameters increase at a non-linear rate.

Referring now to FIG. 1c, as illustrated, the tool shoulder 40 generally comprises a monolithic member. However, the tool shoulder 40 may comprise separate components. In one approach, and as described in further detail below, the tool shoulder 40 comprises a first shoulder portion for interconnection with the body 20 of the friction stir welding tool 10. The tool shoulder 40 may further include a second shoulder portion interconnected to the first shoulder portion near the proximal end of the first shoulder portion and overlaying such first shoulder portion. A second shoulder portion may thus have a working surface proximal a distal end 81 of the pin portion 30 of the friction stir welding tool 10. In turn, a transitioning portion of the first shoulder portion may protrude through the working surface of the second shoulder portion to provide a transition between the pin portion 30 and the working surface of the second shoulder portion. As described below, this transitioning portion may smooth the flow of plasticized material by providing a non-abrupt change in the interface between the tool shoulder 40 and the pin portion 30.

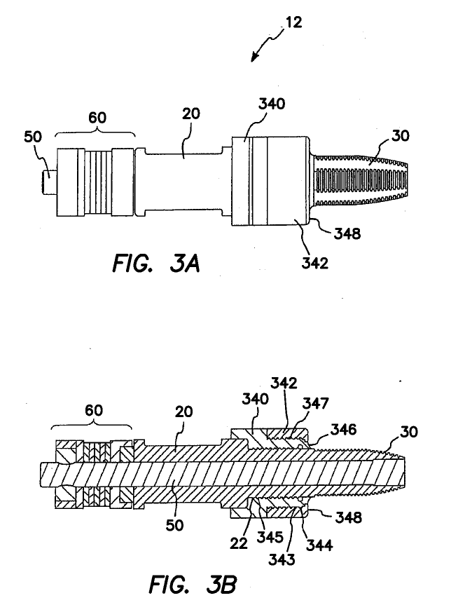

For example, and with reference to FIGS. 3a and 3b, a friction stir welding tool 300 may comprise a body 20, a pin portion 30, a tension member 50, and an end assembly 60, as described above. The friction stir welding tool 300 may further comprise a tool shoulder comprising a first shoulder portion 340 and a second shoulder portion 342. The first shoulder portion 340 may be interconnected to the body 20 via complementary engaging features 22, 345 of the body 20 and first shoulder portion 340, respectively. A second shoulder portion 342 may be interconnected with the first shoulder portion 340, overlaying an outer surface 347 of the first shoulder portion 340. The first shoulder portion 340 and second shoulder portion 342 may be interconnected via complementary engaging features 343, 344 of the first shoulder portion 340 and second shoulder portion 342, respectively. The first shoulder portion 340 may comprise a non-threaded portion 346 having a smooth transitioning surface that protrudes through the working surface 348 of the second shoulder portion 342, thereby facilitating a smooth transition between the pin portion 30 and the working surface 348 of the second shoulder portion 342. Thus, the transition between the tool shoulder 340, 342 and the pin portion 30 may be more gradual (e.g., smoother), thus restricting, and in some instances preventing, the formation of un-bonded discontinuities along the advancing sides of the welds by smoothing the flow of plasticized material at this turbulent point of the friction stir welding tool 10.

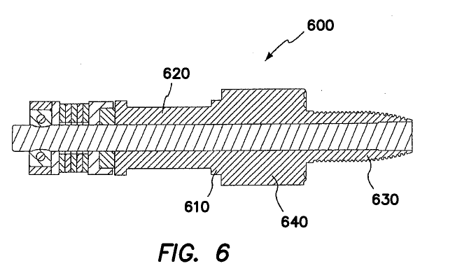

Although in many of the illustrated embodiments, the tool shoulder 40 is illustrated as a separate piece, the tool shoulder 40 may be integral with the body 20 and/or pin portion 30 of the friction stir welding tool, as illustrated in FIG. 6. Hence, in one embodiment, the friction stir welding tool 600 comprises a monolithic structure 610 with the body 620, pin 630 and tool shoulder 640 all being integral with one another. In this embodiment, fabrication processes may be simplified and fabrication costs may be reduced.

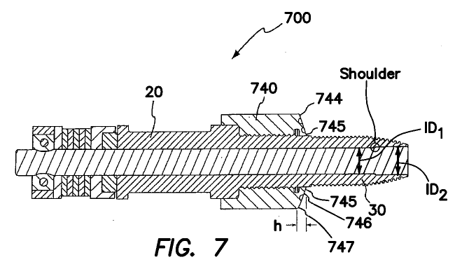

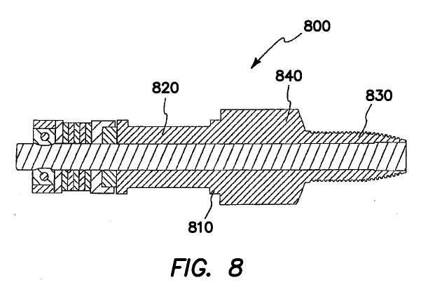

Furthermore, the tool shoulder may comprise a substantially planar working face, as illustrated in FIGS. 1d, 3a, and 3b, or may comprise a non-planar working face. For example, and with reference to FIG. 7, a friction stir welding tool 700 may comprise a body 20 and pin portion 30, such as described above. The friction stir welding tool 700 may further comprise a tool shoulder 740 having a non-planar working surface, such as the tapered working face 744 illustrated in FIG. 7. The tapered working face 744 generally comprises an inner edges 745 and outer edges 747. The height (“h”) of the outer surface 746 of the tapered working surface generally progressively decreases from the inner edge 745 toward the outer edges 747. In one embodiment, the height of the outer surface 746 linearly progressively decreases from the inner edges 745 to the outer edges 747. In one embodiment, the height of the outer surface 746 generally non-linearly progressively decreases (e.g., exponentially) from the inner edges 745 to the outer edges 747. Friction stir welding tools utilizing this tapered tool shoulder approach may be employed with a non-integral tool shoulder, as illustrated in FIG. 7, or may be employed with an integral tool shoulder, an embodiment of which is illustrated in FIG. 8. In the illustrated embodiment of FIG. 8, the friction stir welding tool 800 comprises a monolithic structure 810 with the body 820, pin 830 and tool shoulder 840 all being integral with one another.

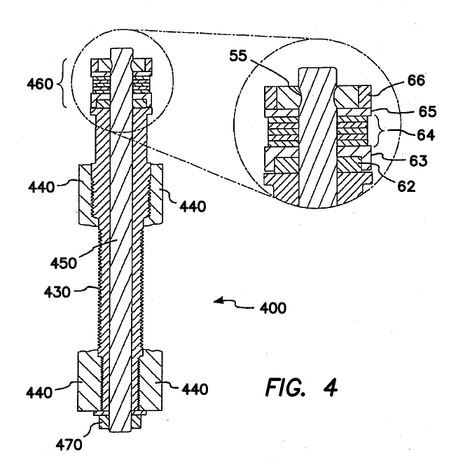

Although many of the above-described features have generally been described in relation to conventional anvil-based friction stir welding tools, bobbin-type tools may also be employed. Such bobbin-type tools may employ various ones of the concepts/embodiments described above. One embodiment of a bobbin-type tool employing an end assembly comprising a decoupling member and a spring member is illustrated in FIG. 4. In the illustrated embodiment, the bobbin-type tool 400 comprises a threaded pin 430, a plurality of tool shoulders 440 interconnected with the threaded pin 430, and a tension member 450 contained within the threaded pin 430. An end assembly 460 is employed at one end of the tension member 450 to provide tension to the tension member 450 and facilitate decoupling of the tension member 450 from the threaded pin 430. The tension member 450 is further mounted to the threaded pin 430 via a physical connector 470 such as a bolt/washer assembly. The end assembly 460 may include any of the features described above with reference to end assembly 60 of the anvil-type tool, such as a decoupling member 62, a retaining ring 63, spring members 64, washer 65 and collar 66. The threaded pin 430 may also include many of the features described above with respect to the pin portion 30 of the anvil-type friction stir welding tool 10, such a high radius to depth ratios and alternating/varying thread orientations, to name two. The tension member may include any of the features described above with reference to engagement portion 55.

FIG. 10 is an illustration of another embodiment 100 having the decoupling member 62 in close proximity to distal end 52 of tension rod 50 instead of being in close proximity to proximate end 54 (FIG. 1c), and a multi-shoulder 40 arrangement having shoulder retainer 102 and split collar 104. As discussed above, the other reference numbers illustrated in FIG. 10 are common with the features in previously disclosed embodiments.

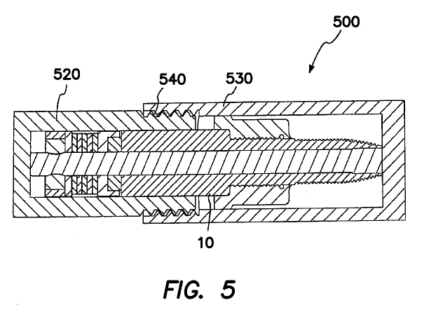

A storage/transportation container may be utilized to store and/or transport any of the friction stir welding tools. One embodiment of a suitable container is illustrated in FIG. 5. In the illustrated embodiment, the container 500 comprises a first portion 520 interconnectable with a second portion 530 (e.g., via complementary male and female threads 540). The first portion 520 is adapted to receive a first portion of the friction stir welding tool 10, and the second portion 530 of the storage/transportation container is adapted to receive the remaining other portions of the friction stir welding tool 10. The internal dimensions of the container 500 may be tailored to the outer dimensions of the friction stir welding tool 10 to provide a snug fit of the friction stir welding tool 10 within the container 500 when the first portion 520 is engaged with the second portion 530. Various types of padding may be employed within the storage container 500. Thus, the friction stir welding tool 10 may be protected during transportation and/or shipment.

### Example of Assembly of One Embodiment Illustrated in FIGS. 1c and 1f

B. Assemble shoulder 40 to body 20/pin portion 30 assembly (unless the body/pin/shoulder are monolithic FIGS. 6 and 8);

C. Insert distal end 54 of tension member 50 into internal bore 21 of body 20 at proximate end 23 of body 20;

D. Axially slide tension member 50 within internal bore 21 until the complimentary engaging features 33, 53 of tension member 50 and body 20, respectively, engage;

E. Slide decoupling member 62 onto tension member 50 and position decoupling member 62 directly adjacent and in contact with distal end 25 of body 20;

F. Slide decoupling retainer 63 onto tension member 50 and position over decoupling member 62 and adjacent distal end 25 of body 20;

G. Slide one or more spring members 64 onto tension member 50 and position at least one spring member 64 directly adjacent and in contact with decoupling retainer 63 (note that the number of springs will influence the compressive stresses induced onto pin portion 30, add as many or as little as necessary to achieve the desired compressive stress condition in the pin portion 30);

H. Slide washer 65 onto tension member 50 and position directly adjacent and in contact with at least one spring member 64;

I. Position a split collar 66 on to distal end 54 of the tension member 50 and insert and loosely secure screws 68 into complimentary threaded holes of split collar 66;

J. Axially push with a press, washer 65 inward toward the spring members 64 to depress the spring members 64 sufficient to expose engagement portion 55 of the tension member 50;

K. Position a split collar 66 to seat within engagement portion 55 of the tension member 50;

L. Tighten screws 68 to secure split collar 66 to the tension member 55;

M. Connect a retainer 67 with the collar 66 to inhibit relative axial movement between collar 66 and distal end 54 of tension member and loosening of the screws from the split color 66; and

N. Attach assembled friction stir welding tool to friction stir welding equipment.

Optionally, apply lubricant as discussed above, and apply additional axial tension during the friction stir welding operation to increase the compressive stresses in pin portion 30.

While various embodiments of the present disclosure have been described in detail, it is apparent that modifications and adaptations of those embodiments may occur to those skilled in the art. However, it is to be expressly understood that such modifications and adaptations are within the spirit and scope of the present disclosure.

What is claimed is:

1. A friction stir welding tool comprising:
a friction stir welding tool body comprising:
a friction stir welding machine drive system interface capable of cooperation with a friction stir welding machine drive system to apply an input rotational speed onto the friction stir welding tool body; and
a pin portion adjacent the friction stir welding machine drive system interface, wherein the pin portion operating at an output rotational speed plasticizes material in a joint to be friction stir welded; and
a tension member having two ends, wherein the two ends being a proximal end and a distal end, wherein the distal end is coupled to the pin portion to induce a compressive load thereon and the proximal end is coupled to the friction stir welding machine drive system interface, wherein an angular displacement of the distal end relative to the proximal end may occur during friction stir welding when the output rotational speed is less than the input rotational speed; and
a decoupling member operatively connected to at least one end of the two ends of the tension member;
whereby a torsional stress within the tension member caused by the angular displacement is reduced when the decoupling member decouples the at least one end of the tension member from the friction stir welding tool body.

2. The friction stir welding tool according to claim 1 wherein the friction stir welding drive system interface is disposed between the decoupling member and the pin portion.

3. A friction stir welding tool comprising:
a body having a length with a distal end, a proximal end, and an internal bore therethrough having an inner diameter along a longitudinal axis, the proximal end including a pin portion;
a plurality of fibers bundled together having a proximal end, a distal end, and an outer diameter along a longitudinal axis, the outer diameter being smaller than the inner diameter of the internal bore, wherein the bundle longitudinal axis and the body longitudinal axis form a substantially common longitudinal axis when the bundle is disposed within the internal bore of the body; and
wherein the bundle interconnects to the pin portion of the body and the distal end of the body and the bundle is further capable of relative rotational movement there-between.

4. The friction stir welding tool according to claim 3 wherein the plurality of fibers are ceramic fibers.

5. The friction stir welding tool according to claim 3 wherein the plurality of fibers are carbon-based fibers.

6. The friction stir welding tool according to claim 3 further comprising an adjustable tension member axial tensile preload device, wherein the axial tensile preload device is a biasing member.

7. A friction stir welding tool comprising:
a tool body;
a pin integral with a proximal end of the tool body, the pin comprising a plurality of threads on the outer surface thereof;
a tension member within and extending at least partially through the tool body, wherein the tension member comprises a shoulder portion near a proximal end of the pin, wherein the shoulder portion is interconnected with a complementary portion of the pin near a proximal end of the pin; and
an end assembly interconnected to a distal end of the tension member, wherein the end assembly is in physical communication with the distal end of the tool body via a decoupling member, and wherein the decoupling member is interconnected with a first portion of the tension member and is capable of restricting transfer of forces from the pin to the tension member.

8. The tool according to claim 7 wherein the tension member comprises a plurality of fibers interconnected to the pin and the tool body.

9. The tool according to claim 7 wherein the tool body and the pin form a monolithic structure.

10. The tool according to claim 9 wherein the monolithic structure further comprises a tool shoulder integral with a middle portion of the tool body, the tool shoulder comprising a working surface facing a distal end of the pin.

11. The tool according to claim 7 wherein the friction stir welding tool is a bobbin-style welding tool.

12. A friction stir welding pin for use with a friction stir welding tool, the pin comprising:
a length having at least three longitudinal segments;
a first longitudinal segment having at least one outer diameter along a length, the length having a proximal end and a distal end;
a second longitudinal segment having at least one outer diameter along a length, wherein the length having a proximal end, middle section, and distal end, wherein the proximal end being adjacent the distal end of the first longitudinal segment; and
a third longitudinal segment having at least one outer diameter along a length, the length having a proximal end and a distal end, wherein the proximal end of the third longitudinal segment being adjacent the distal end of the second longitudinal segment;
wherein the at least one outer diameter of the second longitudinal segment being greater that the at least one outer diameters of the first and third longitudinal segments thereby forming a bulged region in the pin; and
whereby the local hoop-stress field in the bulge region is lowered below the yield strength of the pin.

13. The friction stir welding pin according to claim 12 wherein the at least one outer diameters of the first, second, and third longitudinal segments are substantial constant along their respective lengths.

14. The friction stir welding pin according to claim 12 wherein the at least one outer diameters of the first, second, and third longitudinal segments are not substantial constant along their respective lengths.

15. The friction stir welding pin according to claim 12 wherein:
the at least one outer diameter of the first longitudinal segment increases from the proximal end to the distal end of the first longitudinal segment;
the at least one outer diameter of the second longitudinal segment increases from the proximal end to a predetermined length along the length of the second longitudinal segment, and the at least one outer diameter of the second longitudinal segment decreases from the predetermined length to the distal end of the second longitudinal segment; and
the at least one outer diameter of the third longitudinal segment decreases from the proximal end to the distal end of the third longitudinal segment.

16. The friction stir welding pin according to claim 15 wherein the at least one outer diameter of the distal end of the first longitudinal segment is substantially equal to the at least one outer diameter of the proximal end of the second longitudinal segment, and the at least one outer diameter of the distal end of the second longitudinal segment is substantially equal to the at least one outer diameter of the proximal end of the third longitudinal segment.

17. The friction stir welding pin according to claim 16 further comprising a plurality of threaded segments circumscribing the outer surface of the pin for a portion of the length of the pin and at least two thread-less longitudinal sections spanning the entire length of the pin that form equidistance spaces between the plurality of threaded segments.

18. The friction stir welding pin according to claim 17 wherein at least one threaded segment of the plurality of threaded segments is left-handed threads and another at least one threaded segment of the plurality of threaded segments is right-handed threads.

19. The friction stir welding pin according to claim 17 wherein all the threaded segments of the plurality of threaded segments are all left-handed threads or all right-handed.

20. The friction stir welding pin according to claim 12 wherein at least one segment comprises a plurality of outer diameter that increase or decrease relative to each other at a linear rate.

21. The friction stir welding pin according to claim 12 wherein at least one segment comprises a plurality of outer diameters that increase or decrease relative to each other at a non-linear rate.

22. The friction stir welding pin according to claim 20 further comprising at least one segment comprises a plurality of outer diameters that increase or decrease relative to each other at a non-linear rate.
